(19) United States
(12) Patent Application Publication
(10) Pub. No.: US 2015/0096603 A1
(43) Pub. Date: Apr. 9, 2015

(54) Cover for Stroller or Car Seat

(71) Applicant: Keren Nadel, Woodland Hills, CA (US)

(72) Inventor: Keren Nadel, Woodland Hills, CA (US)

(21) Appl. No.: 14/047,288

(22) Filed: Oct. 7, 2013

(51) Int. Cl. E04H 15/06; B60N 2/28; B60N 2/58; B60N 2/60

(52) U.S. Cl. CPC E04H 15/06; B60N 2/60; B60N 2/2839; B60N 2/5891
USPC 135/88.02; 297/184.13; 297/184.12; 29/428

(57) ABSTRACT

Disclosed is a covering for an infant carrying device having a size adjustment element allowing for adjustment of the size of the covering, such that the covering can be adjusted to over a variety of different infant carrying devices, including strollers and car seats of different models.

### BACKGROUND

### Field of the Invention

The present invention relates to a cover for a baby transport device.

### DESCRIPTION OF THE DRAWINGS

FIG. 1 is a top plan view of the cover laid flat on top of a stroller's hood. The cover is shown in phantom and extends past the stroller's hood only in this picture to differentiate between the cover and the stroller's hood.

FIG. 1.1 is a top plan view of the cover on a stroller's hood. A vertical dotted line running down the center divides the two sides. Attachment devices are also represented.

FIG. 2 is a top plan view of the cover on a stroller's hood where the attachment devices comprised of cinches, snaps or other closing devices are represented in two rows.

FIG. 3 is a top plan view of the cover on a stroller's hood where the attachment devices and configuration represented in FIG. 2 are shown in an engaged position.

FIGS. 4, 5 and 7 are top plan views of the cover on a stroller's hood where the attachment devices comprised of cinches, snaps or other closing devices are represented in four rows. A dotted arrowed line from one attachment device to its mate in each of the figures represents the various types or configuration of attachments that can be made. The stroller's hood in FIG. 7 is shaped differently than the hood in Figure's 4 and 5.

FIG. 6 is a top plan view of the cover on a stroller's hood where the attachment devices comprised of cinches, snaps or other closing devices are represented in six rows. Dotted arrowed lines from one attachment device to its mate represent the various types or configuration of attachments that can be made.

FIG. 8 is a top plan view of the cover on a stroller's hood where the attachment devices are comprised of one set of mating Velcro strips. The shaded portion on the Velcro strips represents where the strips might be engaged.

FIG. 9 is a top plan view of the cover on a stroller's hood where the attachment devices are comprised of two sets of mating Velcro strips.

FIG. 10 is a top plan view of the cover on a stroller's hood where the attachment devices are comprised of a linking or tying device.

FIG. 11 is a top plan view of the cover on a stroller's hood where the attachment devices comprised of linking or tying devices that are engaged

FIG. 12 is a top plan view of the cover on a stroller's hood where the attachment devices are comprised of linking or tying devices that are not engaged. A gap in material at the center of said cover's material is also shown.

FIG. 13 is a top plan view of the cover on a stroller's hood where the attachment devices are comprised of four rows of cinches, snaps or other closing devices that are unengaged. Also included is an attachment device meant to attach to the stroller's handle bars compromising of one rectangular shaped cloth extending from the back top of the cover.

FIGS. 14 and 15 are top plan views of the cover on a stroller's hood where the attachment devices and configuration represented in FIG. 13 are shown in different engaged configurations. The attachment device meant for handle bar attachment depicted in FIG. 13 is also shown at different widths that resulted from the various attachment configurations of the cinches, snaps or other closing devices.

FIG. 16 is a top plan view of the cover on a stroller's hood where the attachment devices are comprised of two rows of cinches, snaps or other closing devices that are unengaged. Also included is an attachment device meant to attach to the stroller's handle bars comprising of two separate straps extending from the far ends of the back top of the cover.

FIG. 17 is a top plan view of the cover on a stroller's hood with the attachment devices, depicted in FIG. 16, engaged. The attachment device meant for handle bar attachment depicted in FIG. 16 is also shown at a different position that resulted from the engagement of the rows of cinches, snaps or other closing device.

FIG. 18 is a side view of the cover

FIGS. 19 and 20 are perspective side views of the stroller cover shown in phantom, placed over a conventional single stroller

FIG. 21 is a plan side view on the cover shown in phantom, placed over a conventional car seat.

### PURPOSE

The Purpose of this Invention Includes Some or all of the Following:

1. To block sunlight out of a stroller or an infant/baby car seat.
2. To insulate the child in the stroller or car seat from cold weather.
3. To protect child from wind and bugs.
4. To allow for airflow while child is sheltered under cover.
5. To allow for viewing of child while sheltered under cover.
6. To allow parent easy access to child while sheltered under cover. This can aid in passing objects through back and forth.
7. To allow for fast and easy installation on top of car seat or stroller
8. To allow for a secure fit on the car seat or stroller
9. To allow for fast and easy alternate use between car seat and stroller.

### SUMMARY

This product is designed as a cover that can be used interchangeably with a car seat and stroller. The cover is adaptable to fitting on top of various sized hoods of strollers by a mechanism that allows for the cover to expand or narrow.

The cover is essentially a cloth sheet that is placed or fitted on top of an opened stroller or car seat hood, and then hangs off said hood to close off or shelter the seating area of the stroller or car seat. To function properly, the stroller's hood must be opened, preferably as far forward as is allowed. Also, if it exists within the particular stroller, the tray or bar that is typically found in front portion of a conventional stroller or in front of the seat of a conventional stroller should not be removed. For purposes of a car seat, the hood must also be opened as far as it can extend and the handle bar placed in an upright position. The cover can be placed on a stroller or car seat set up in these positions.

### DETAILED DESCRIPTION

### Top Portion:

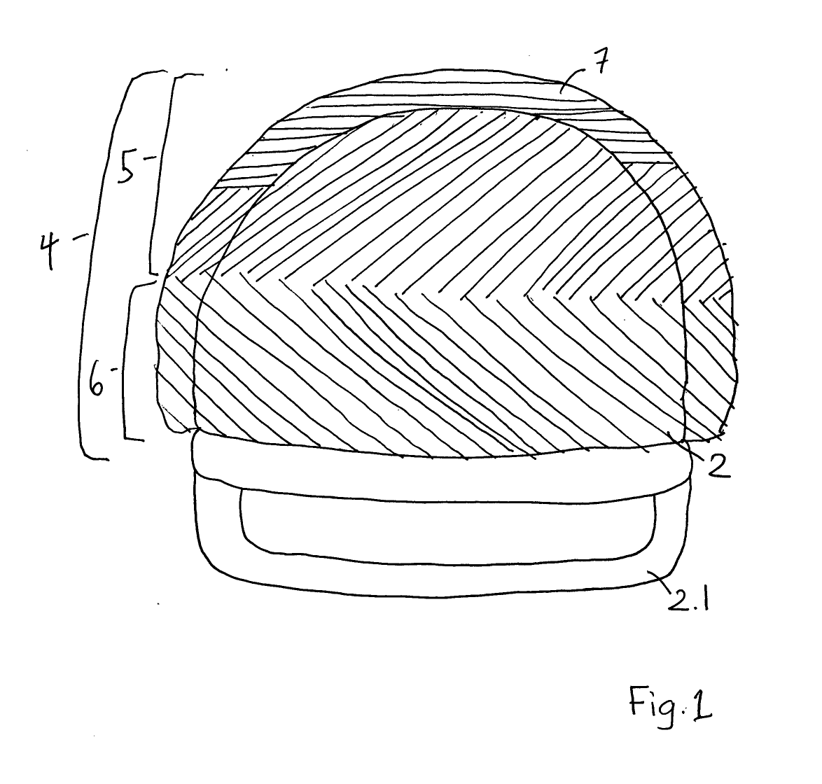

FIG. 1 is an overhead view of a stroller 1 with an opened hood 2 with the cover 3 placed on it. The handle bar 2.1 of the stroller is also shown. The whole top portion 4 of the cover 3 refers to the whole portion of the cover 3 that lies on top of the stroller's hood 2. It should be noted in FIG. 1 that the top of the cover 4 extends beyond the stroller's 1 hood 2 in order to differentiate the hood 2 from the top of the cover 4; however in actual application, the top of the cover 4 would not extend outward as such, but lie directly on top of the hood 2.

For clarity of reference, the top of the cover 4 is divided horizontally into two sections. The “front top” 5 of the top of the cover 4 refers to any portion of the cover that lies on top of the stroller's 1 hood 2 and starts from the front to halfway down to the back of the stroller's hood. The “back top” 6 of the cover refers to any portion of the cover that lies on top of the back portion of the stroller's hood. This area runs from the back of the hood to halfway towards the front. For identification purposes, in FIG. 1, these portions of the cover are shaded in differing slanted lines. Also, for sake of clarity, the “very top front”7 portion of the cover is the portion of the cover that would lie directly over the front arch of the hood of a conventional stroller. This portion is block shaded for clarity.

The top of the cover 4 drapes over the length of the stroller's 1 hood 2 and sits over the arch 7 of the hood. In order to accommodate different shaped hoods, the area starting from the front top 5 portion of the cover and running down to the back top 6 portion, includes fastening or closing elements, preferably comprising of counter mating components. Said element is designed to narrow the horizontal width of the cover's top 4. Said element can consist of one or more rows or strips of individual snaps, buttons or some other kind of cinching or closing device and one or more rows or strips of matching counter-mates. Said element can also consist of one or more strips of Velcro and its matching counterparts, or a zipper or zippers also running from the front top 5 to the back top 6. Said element can also consist of a row of strings, bands or any other material that can link or tie together.

The Placement and Engagement of the Row(s) of Snaps, Buttons, Velcro, String or any Other Attachment Device:

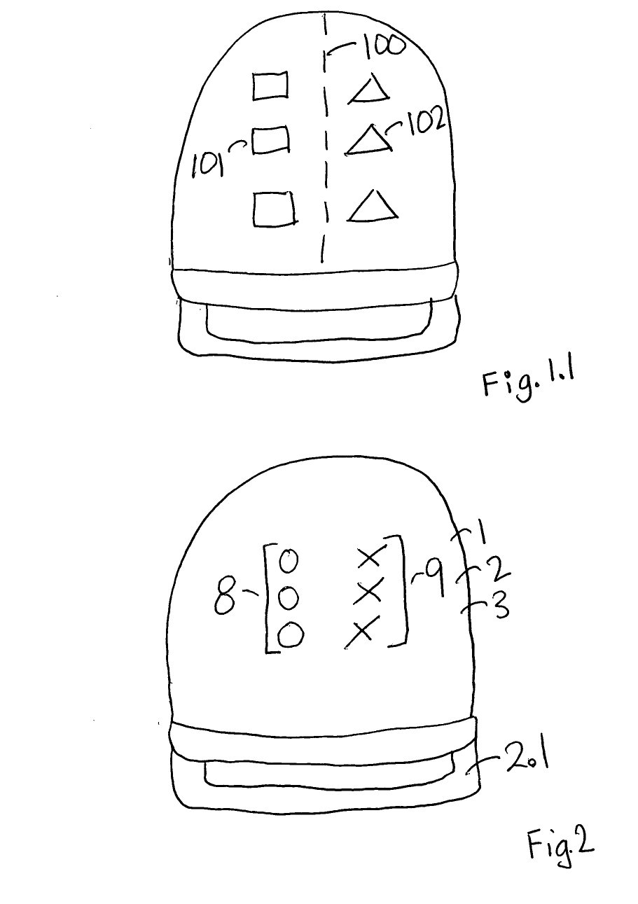

In FIG. 2.1 the center of the top of the cover is represented by a dotted line intersecting it in half and will be referred to as the “top center divide” 100. The rows of snaps, buttons, Velcro, ribbon or any other attachment devices, represented by squares 101 and their attachment mates, represented by triangles 102¹, on either side of the top center divide 100, can be placed as many inches away from it as needed to achieve the most utility for the cover to accommodate most stroller hoods. The distance from the top center divide 100 to an attachment device on either side is any length that best accomplishes the invention's purpose or utility, or preferably nine inches. The attachment devices on either side of the top center divide 100 will be an equal distance apart. Where additional rows are provided, the distance of one row of attachment device(s) to another row of attachment devise(s) on one side of the top center divide can preferably be between one to five inches apart or any distance that provides the cover with the best utility. The configuration of distances between the rows on one side of the top center divide will repeat on the other side of the top center divide. ¹ In the case of ribbon, string, belt attachment or other type of tying device, the mating device of those attachments is the loop that the ribbon string or belt would go through on the other side of the top center divide, or another ribbon string, belt or other type of tying device. This will be discussed in further detail later on.

After being tested on various stroller hoods, the stroller cover can include a reference guide that advises the buyer where or how exactly to attach the aforementioned attachment devices for his/her particular stroller.

When these attachment devices engage, the top of the cover 4 takes on a different shape. To illustrate, suppose there was only one pair of attachment rows on the top of the cover 4. Such device is represented collectively by x's 8 and o's 9 in FIG. 2 wherein each x counter mates with corresponding component o.

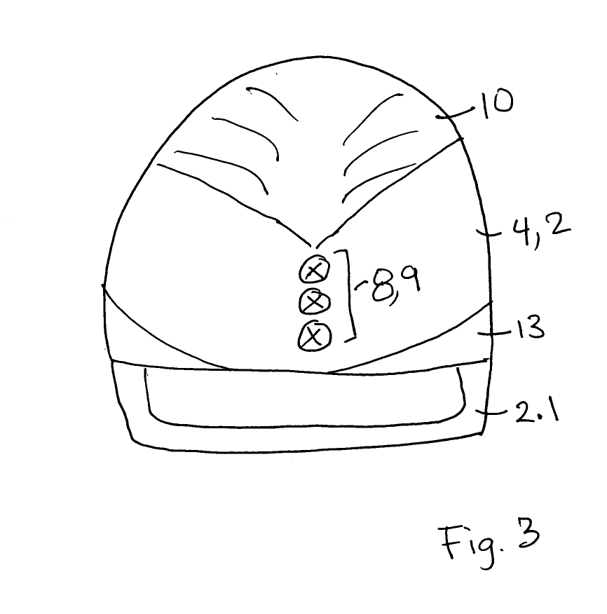

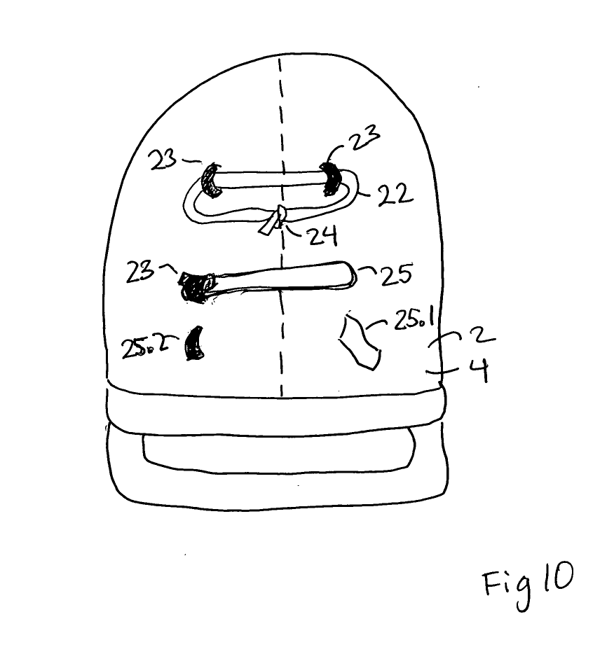

By engaging these attachments, what occurs is that the top front 5 portion gets pulled in by the attachments. As will be discussed, later, this pull helps create a small pocket of space when the cover gets placed over a car seat, which allows for easier gripping of the car seat's handle. The direction this pull 10 takes is depicted in FIG. 10. This pull 10 also helps in allowing the cover to better grab or place itself onto the front edge of the stroller's hood at the very top front 7 of the cover. Please note that in FIG. 3 and some of the one's following, the engaged snaps are represented by x's 8 inside of o's 9.

When the snaps are engaged, what also happens is that the top back 6 portion of the cover loses somewhat its rectangular-like shape and takes on a more triangular look. Also, please note that this results in some portion of the hood 2 becoming exposed.

### A Row of Cinches, Snaps or Other Closing Devices—

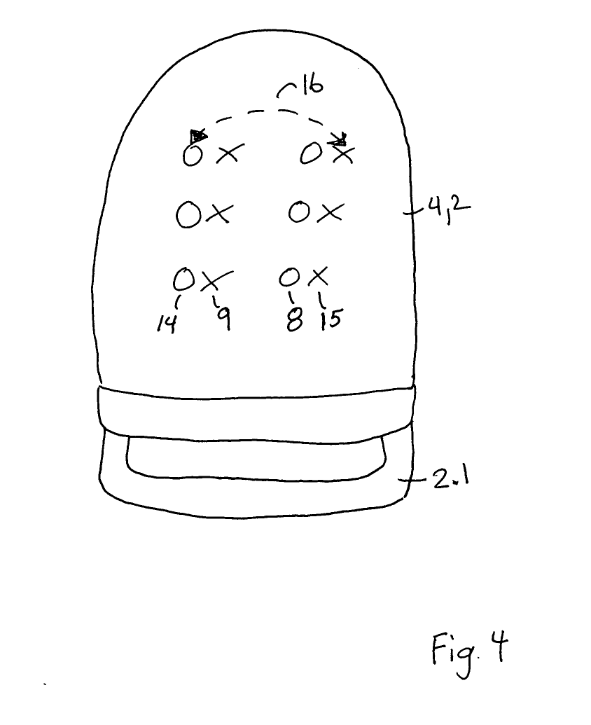

FIGS. 2 and 3 show one example of a certain configuration of rows of cinches, snaps or other closing devices unengaged and engaged. FIG. 4 illustrates another example of how the cover could cinch with these types of devices by depicting the two pairs of cinching rows 8, 9 along with two more rows 14, 15 on top of the cover 4. While only three o's 14, 8 and x's 9,15 are shown in each of the rows, more can exist if needed. Here, the furthest row of x's 15, can attach to the mating corresponding furthest row of o's 14 that lie horizontal from each other. This attachment, which can be repeated all the way down the row, is depicted by a dotted arrow 16.

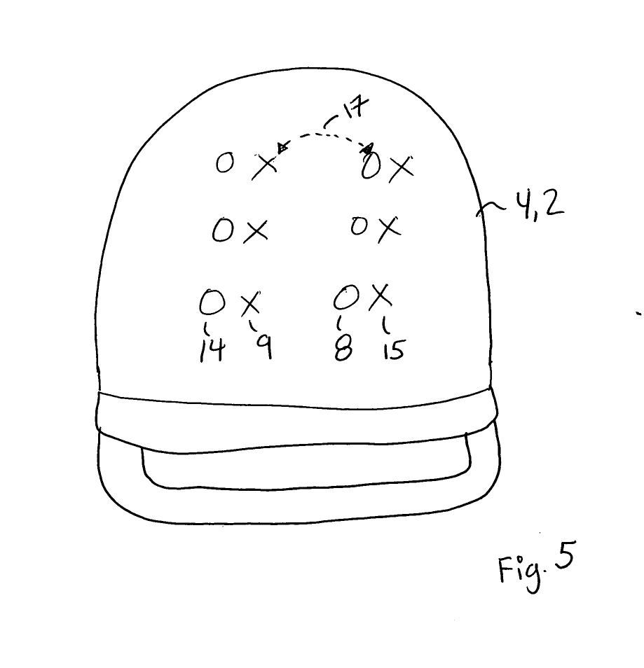

If a narrower fit of the top of the cover 4 on the stroller's hood 2 is desired, the more inlaid o 8 can attach to its inlaid x 9 that is its horizontal mate. This attachment configuration, which can be repeated all the way down the row, is depicted in FIG. 5 by a dotted arrow 17.

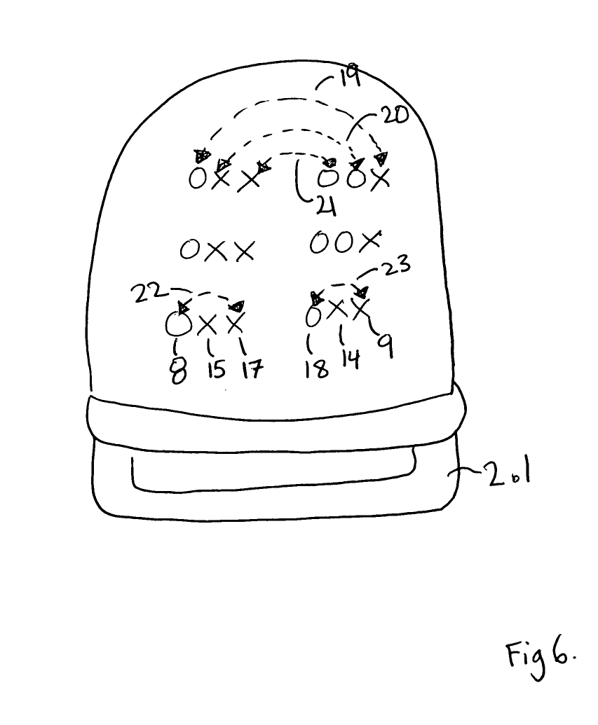

If an additional row of x's 17 and o's 18 are added horizontally, there can be even more configurations of attachments. Some of these configuration options are depicted by the dotted arrow lines in FIG. 6 (19, 20, 21, 22, 23). The possible configurations multiply the more rows are added. The user can utilize any configuration he/she requires as he/she moves down the rows in order to accommodate their particular stroller.

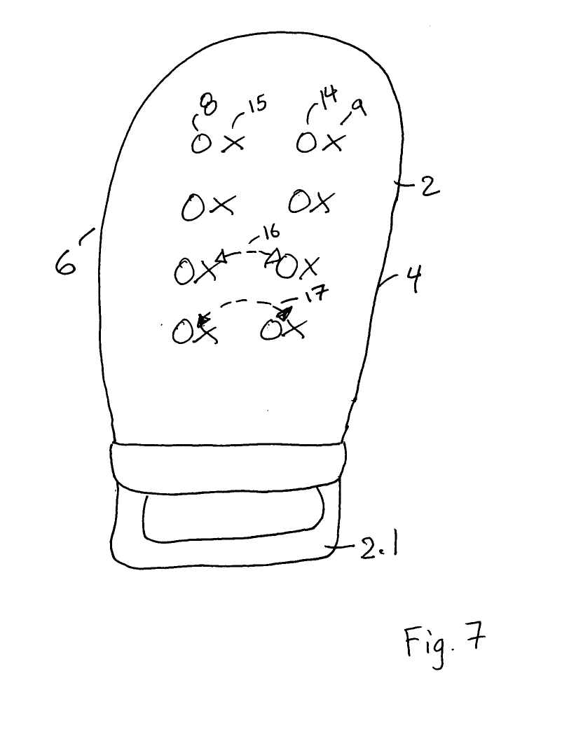

For example, a stroller hood 2.1 that starts out wide in the front and narrows as it moves towards the back may require the user of the cover to forgo utilizing the first couple snaps in the rows, and then begin snapping in a manner that would create a more narrow width in the back top. Thus, in FIG. 7, while the first two o's in the row of o's 8, 14 and the first two x's in the row of x's 15, 9 are not engaged, the third innermost x in the innermost row of x's 15, would attach to the third innermost o in the innermost row of o's 14. This configuration is represented by a dotted arrow 16. Then to narrow the top of the cover even more, the next o down the row leading towards the back top of the cover 6 in the outermost row of o's 8 would then attach to the next x down the row leading towards the back top of the cover 6 in the outermost row of x's 9. This configuration is represented by a dotted arrow as well 17. Making attachments in this manner, creates a cover top 4 that is wide towards the front and narrower as it moves further down towards the back.

### Velcro Strips—

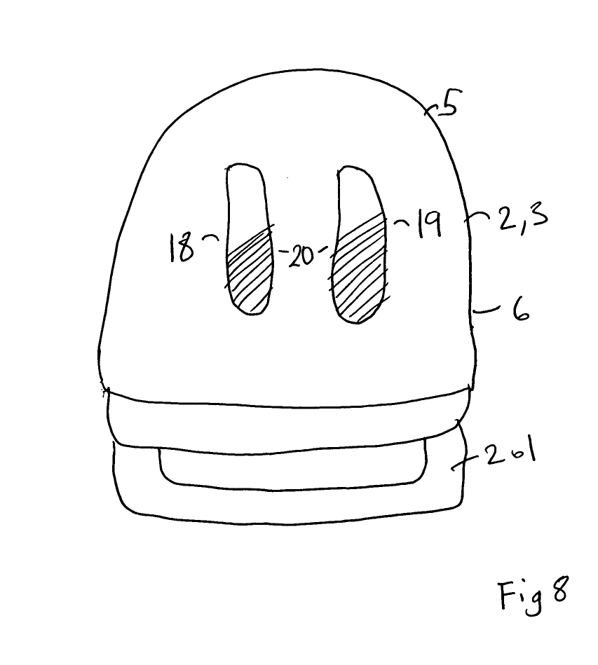

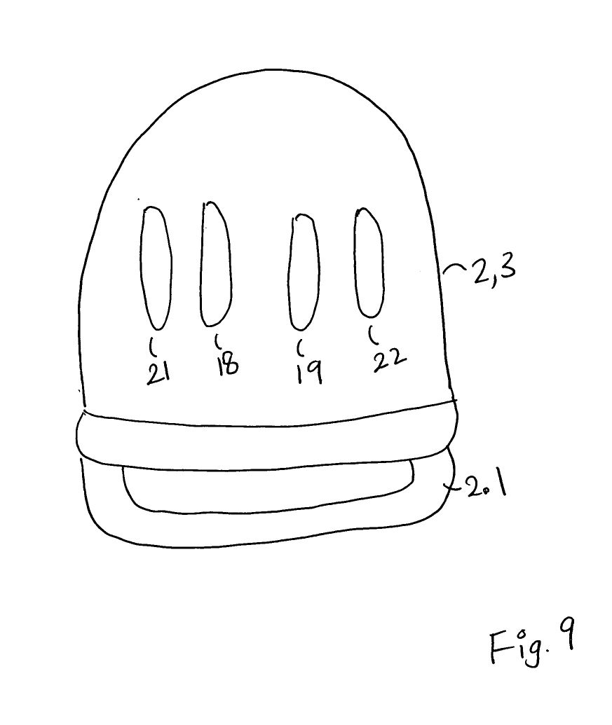

Velcro strips can be utilized as the fastening element, preferably comprising of two mating Velcro strips 18, 19 placed on the top of the cover 3 running from the front top 5, to the back top 6. In order to narrow the top of the cover 4, the user of the cover 3 can simply connect the two adjoining strips at any point that is best suited to the user's individual's stroller's hood. For example, in FIG. 8, the shaded portion of the strip 20 represents a portion of the Velcro that might be engaged. As with the use of snaps or buttons, the Velcro strips can include more than one attaching and receiving rows FIG. 9 (18, 19, 21, 22).

### Linking or Tying Device:

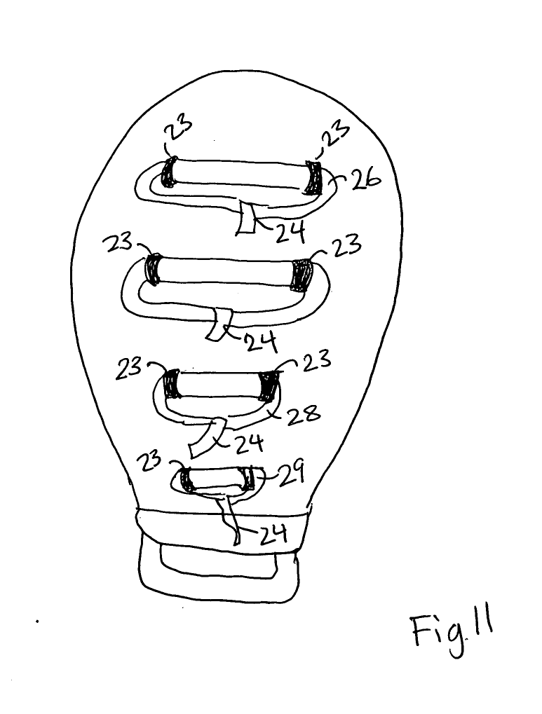

The attachment devices used can also be a string, belt, ribbon, band or any other device that can tie or link. The mating device can be a loop, tightening strap buckle, a hole cut into the fabric, a ring or any other device that can mate with the aforementioned attachment devices. For example, in FIG. 10 a strap 22 can go through two loops or rings 23 located on either side of the top center divide 100, and then run through a tightening strap, which allows for the strap to be elongated or shortened as desired. In another example, the ribbon 25 is sown into the top of the cover 4, and then goes through a loop 23 on the other side of the center divide 100 where the ribbon can be pulled through and then tied to itself or around a loop to allow for the ribbon to either lengthen or shorten. For clarity, the third tying device shown in FIG. 10 is the same as the device shown directly above it where a string is sewn into the fabric on one side 25.1 of the top center divide 100 and a loop 25.2 on the other side; however, in this illustration, the string and loop are unengaged. The means for utilizing the tying or linking devices are not limited to the examples listed here, but can be any means used by someone skilled in the art. By elongating the linking or tying attachment device, the top of the stroller cover 4 is allowed to expand horizontally. By tightening said device, the top of the cover 4 is allowed to narrow horizontally. When the row of such devices running down from the top front 5 to the top back 6 of the cover are engaged at the desired position, the result is the stroller cover top 3 better accommodating different sized stroller hoods 2. For example, FIG. 7 presented a stroller hood 6 that was shaped wider in the front and narrower in the back. If the tying or linking device were utilized on the top of the cover 4 for such a stroller, then perhaps the first two tying devices 26, 27 near the front top 5 in the row would be allowed to expand or be let loose as much as possible, while the next tying device in the row 28 would be pulled in or shortened; and further still, the next tying device in the row 29 would be pulled in or shortened even more. Please note in FIG. 11 that the portion of the ribbon that comes out of the strap tighteners 24 used in the first two attachment devices 26 and 27 are short and its loops, 23 remain far apart; while the portion of the ribbon that comes out of the strap tightener 24 in the third attachment device 28 is longer, and its loops 23 are pulled in closer together. Also, please note that the portion of the ribbon in the fourth attachment device 29 that comes out of the strap tightener 24 is longer than all the other portions of the ribbons 26, 27, 28 that come out of the strap tightener, and its loops 23 are pulled in closest to each other. The distance between two mating linking devices would preferably be nine inches apart and of equal distance from the top center divide 100. In other words, if a string and loop were used for example, the string would be nine inches away from the loop and lie four and half inches on one side of the top center divide 100, while the loop would lie four and half inches on the other side of the top center divide 100.

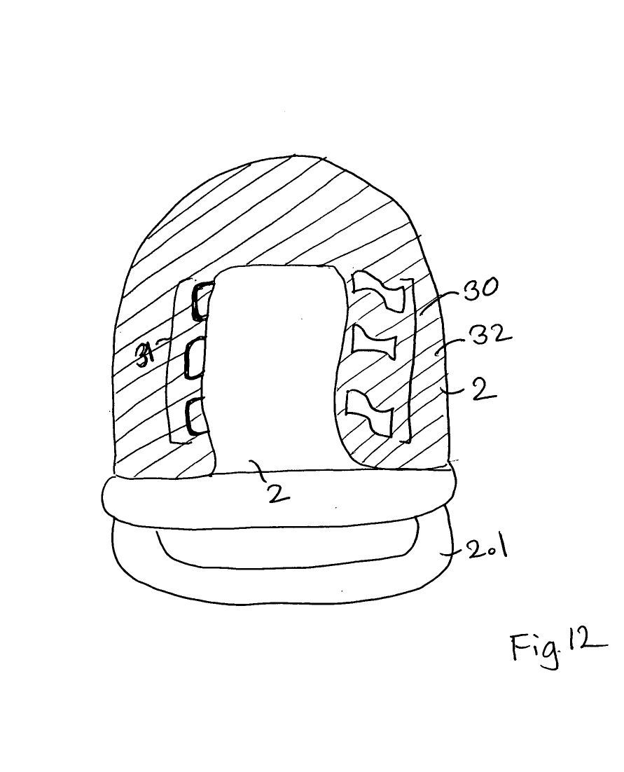

### Gap in Material:

Where a linking device is used, the cover top has the option of leaving out material from a portion of the top preferably in the center. The gap in material can start at some point that serves the best utility at the top portion of the cover 5, while the width would preferably be nine inches. FIG. 12 is a top plane view illustration of the top of the cover 4 that is missing the center material 30 and is laid flat on top of a stroller hood 2. The top of the cover is shaded in order to differentiate between it and the hood of the stroller 2, which is exposed. The linking devices depicted in FIG. 12 are loops 31 and strings 32. Please note that in the picture they are located on either side of the gap in material and are unengaged. Consequently, each linking device and its mate would preferably be about nine inches apart.

### Method of Attaching Cover to Handle Bar

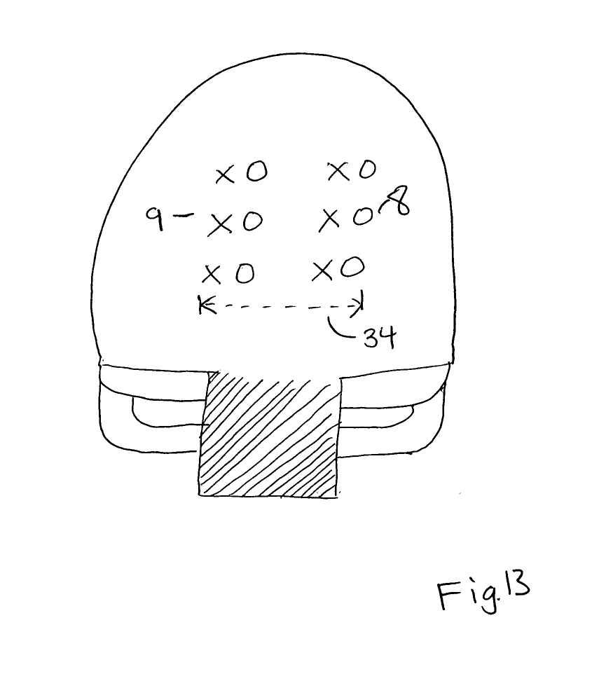

The cover can also include a means of attaching itself to the handle bar(s) of a stroller. There are two means suggested here. The first is created by elongating the length of the back top 6 of the cover (hereinafter referred to as the “elongated top” 33). The width of this extension would be the length from the two outermost rows of attachment devices. For example, if the length between two mating attachment devices is nine inches, then the width of the elongated top would be about nine inches as well. This portion of the material would extend a couple inches out beyond the end of a typical stroller's hood so that it hangs off the handle bar of the stroller. In FIG. 13, the elongated top 33 is shaded for clarity. Please note how the width 34, depicted by a dotted arrowed line, of the elongated top 33 runs from the length of the furthest rows of x's 9 to the furthest rows of o's 9. Please note also how the length of the elongated top 33 extends just a couple inches beyond a stroller's handle bar 2.1.

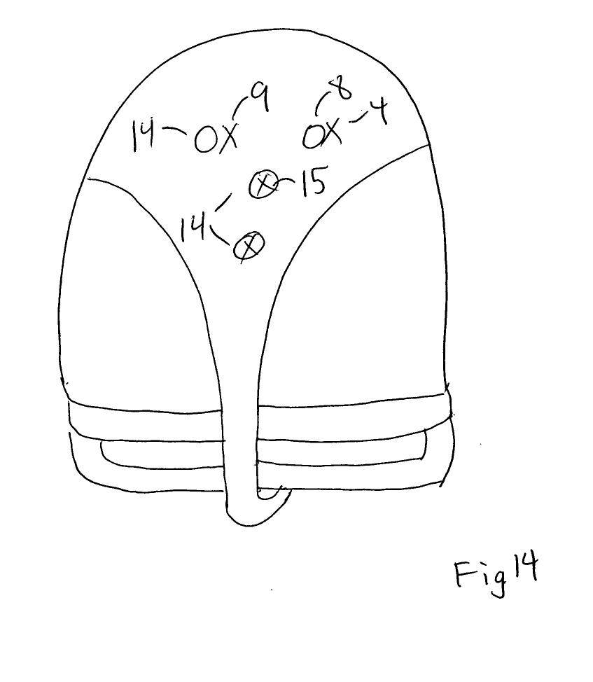

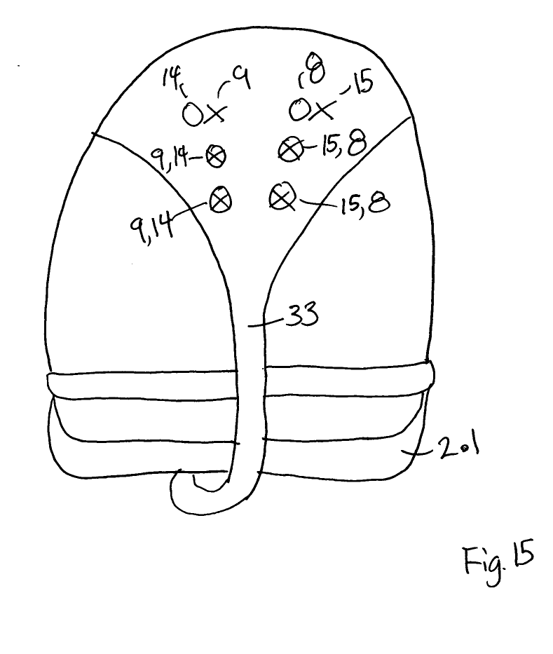

When the attachment units of the top of the cover are engaged, the elongated top narrows to create a tail end piece that will be available for wrapping around the handle bar. It may be thinner or wider depending on where the attachment devices are engaged. FIGS. 14 and 15, are top plane views of the top of the cover 4 with the same configuration of attachments found under FIGS. 4 and 5. The first row of attachments (14, 9, 8, 15) in FIG. 14 are unengaged, the second and third rows show the furthest row of x's 15 engaging with the furthest row of o's 14. Notice how this configuration of attachments causes the whole top of the cover to narrow along with the elongated top 33. Also, for sake of clarity, please note that the innermost x's in the row 9 and the innermost o's in the row 8 are out of view once the furthest rows of x's 15 and the furthest row of o's 14 are engaged.

In FIG. 15, the first row of attachment devices (14, 9, 8, 15) are unengaged. In the second and third rows, the o's 14, 8 and x's 15, 9 directly adjacent to each other are engaged. Please note, how this attachment configuration causes the top of the cover 4 to narrow but not as much, which results in the elongated top 33 narrowing as well, but not as much.

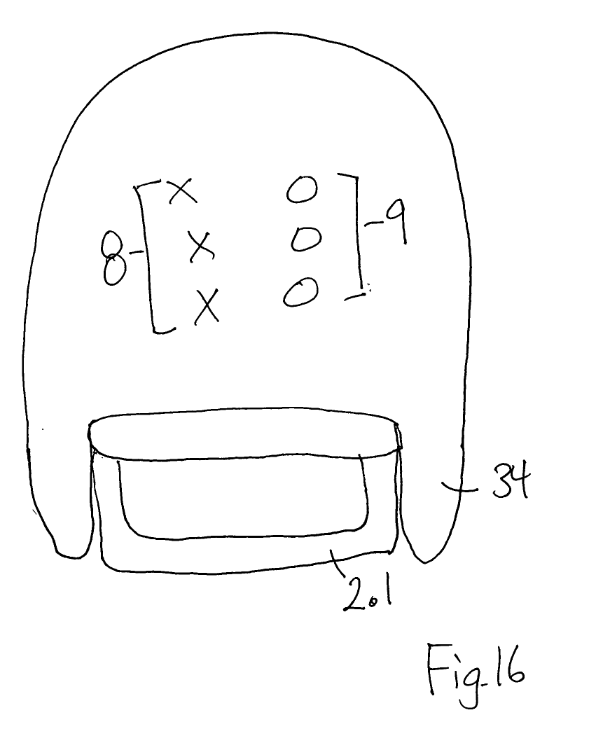

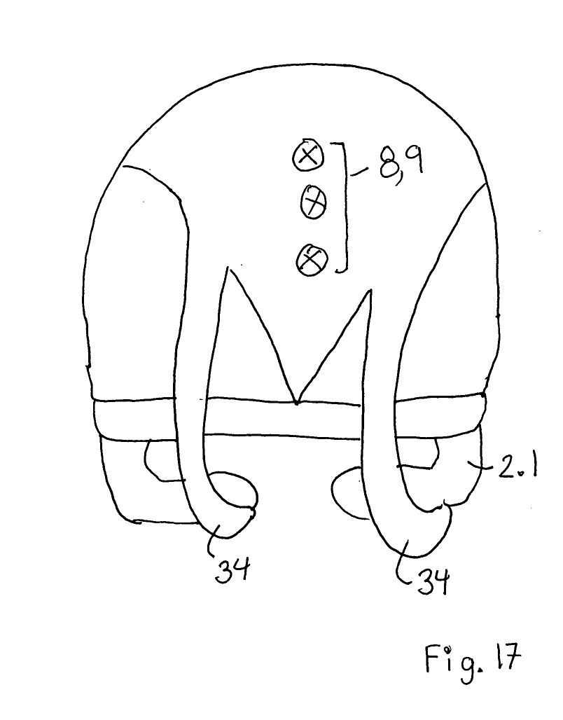

The second means of attaching the cover to the handle bars of a stroller is depicted in FIG. 16. Here, two straps 34 extend a couple inches out on both sides of the back top 6. FIG. 16 is a plan view of the top of the cover 4 laid flat on the hood of a stroller with this type of extension. FIG. 17 is a plane view of the top of the cover 4 with said straps, where the fastening devices 8, 9 are engaged. Please note that the handle bars in conventional strollers can connect 2.1, or be two separate, non-connecting handles 2.2. In FIG. 17, the engagement of the attachments has resulted in the two straps 34 moving closer to the edges of two disconnected handle bars 2.2. If one connecting handle bar 2.1 was in place, the straps would move closer to its center. This second mechanism for handle bar attachment may be helpful for use of strollers that have two non-connecting handle bars 2.2. instead of one since the first described handle bar attachment mechanism could not wrap around two disconnecting handle bars. Two straps may also allow for greater stability and guidance when fitting the cover on top of the stroller.

Either the two straps 34 or the elongated top 33 can preferably be long enough to simply tie around the handle bar(s)(2.1, 2.2) of a stroller, or they can include some form of attachment mechanism that allows the user to attach the straps 34 or the elongated top 33 to itself after it/they are wrapped around the stroller's handle bars (2.1., 2.2).

Please note that in all the examples illustrating the various types of handle bar attachments for the cover, either the elongated top 33 or the two straps 34, the forms of attachments on the top of the cover 4 depicted have been buttons or snaps; however, the use of stroller handle attachments 33, 34 is not limited to covers using buttons or snaps on the top of the cover 4. These types of attachments were utilized in the illustrations simply to help clarify how the stroller handle attachments 33, 34 would appear with various widths created for the cover's top 4. The same widths can be created with different forms of attachments such as Velcro or strings, and the resulting widths of the handle bar attachments 33, 34 would appear similarly.

### Length of Top of Cover

The length described here is the length of the top of the cover when laid flat open on the stroller's hood. It would be measured from the center of the very top front 7, to the back top 6. This length does not include the length of the straps 34 or the length of the elongated top portion 33, whichever is implemented. The length of the top of the cover 4 should preferably be 21 inches.

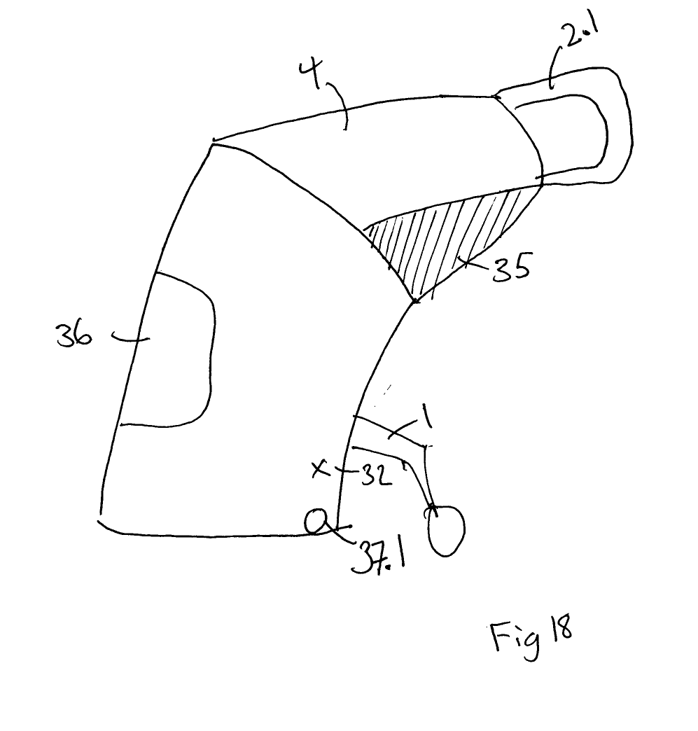

Please note that this length is measured only from the center of the very top front 7 of the cover. Since the very top front 7 mimics the shape of the stroller's arch, and the whole top portion 4, drapes over the arched shaped stroller's hood, this length from front to back cannot be uniform throughout. The length is also varied at the sides of the top 4 where the material would drape over the sides of a conventional stroller hood. In FIG. 18, this area, called the top side 35 is shaded for clarity.

The length of the two straps, or the elongated top, whichever mechanism is utilized, should be any length best suited for the purpose of wrapping or attaching itself to the handle bar(s) of a stroller.

Length of Front and Side of Cover from Top to Bottom

The length of the cover from the front portion that hangs off the hood to front bottom will preferably be 34 inches. With regards to the material that would hang off the stroller's hood at the sides, this length will be shortened somewhat in comparison to the front since the material will be at some degree of a slope. The slope would mimic the slope that is found on a typical stroller's side parallel back bar (the one that attaches to the handle bars).

FIG. 18, is a side view of the cover. The front opening 36, which will be discussed later, is also shown. This side sloped portion begins from the bottom at a cornered edge, 37.

The length of both the sides and front portions of the material that would hang off the stroller's hood can have the option of being shortened to some extent through attachment devices such as buttons, snaps, linking string or ribbon devices, zipper or any other attachment devices suited for this purpose. The attachment device shown is depicted by an o 37.1, located the cornered edge 37. It will mate with the x 37.2 above it at the sloped edge. The distance between them is preferably eight inches. These devices will be located on both sides of the cover.

Also note, the cover on either side of the stroller will be the identical in size, length and width on both sides. Thus, if folded in half, both halves will be the same. The slope mimics the slope that is found on a typical stroller's side parallel back bar (the one that attaches to the handle bars).

### Fringe of Material:

At the fringe, frame or outer parameter part of the cover, there should be a boarder that is more substantial or heavier than the rest of the material preferably as a result of some form of rope, twine or any material that serves this purpose sewn into it. The purpose of adding weight to the fringe is to allow for the cover 3 to sit more fitted on top of the car seat or stroller. This would occur because the weight of the fringe will create a pull on the cover causing the material to be more evenly distributed. A weighted fringe also helps avoid the material from flying off the carriage or car seat in case of wind.

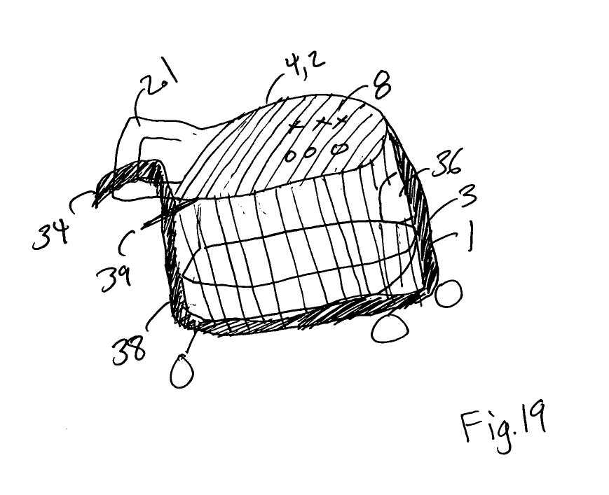

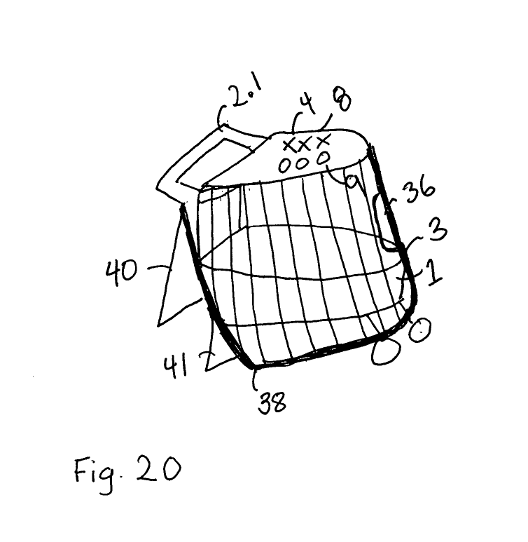

This weighted framing will surround the cover all around in the front bottom portion and then go up the sides to the top. FIG. 19 is a side perspective view of the cover fitted onto a stroller. The weighted fringe 38 is shaded for clarity. When the two strap mechanism 34 is utilized, the straps have the option of being part of the weighted fringe 38, so that they are just an extension of it. When the elongated top 33 is the method in place, it can also be part of the weighted fringe so that it rides all the way up to that portion of the cover. Also, regardless of which technique is used, the weighted fringe can end at the top of the cover. A horizontal line 39 in FIG. 19 represents the point where the weighted fringe could end.

### “Extra Material”

As an option, attached to the weighted fringe at the sides, can exist “extra material”40, so named because it's potential for being placed just outside the weighted fringe 38 that frames the cover; however, it can also be placed within the weighted fringe 38. This extra material can be in any shape. Preferably it will be in the shape of a right triangle. The purpose of this extra material will be to wrap around the sloped back bar of the stroller 1. When it is wrapped around the bar, the cover will be more wind resistant. It's purpose could also be to give the user the option of adding more coverage to the side of the strollers

There can also be an additional smaller piece of extra material 41 that is just beneath the larger piece of extra material 40 just described. It also has the option of being outside or inside the weighted frame 38 of the cover. This piece will likely be a smaller triangular piece that is meant to wrap around the bars that ultimately attach to the stroller's back wheels.

On the underside of either of these extra materials 40, 41 will be a patch of Velcro or some other attaching device. Another patch of Velcro or attaching device meant to attach to the devise on the extra materials 40, 41 will be located on the underside of the cover 3 itself. Since the Velcro or other fastening devise is on the inside and not visible to the user when the cover is placed on the stroller, there can also be some guide on the visible outside portion of the cover to guide the user on where attachment can be made. In other words, the outside visible portion of this extra material can indicate where the Velcro patches or other fastening device lies underneath by marking them in some manner such as outlining the boarder of the Velcro. When using Velcro, the Velcro patches should be large enough to accommodate different strollers. There can also be an option for the user to remove this “extra material” out of sight by Velcroing or fastening it back inside the cloth.

Both these extra materials 40,41 can be found framed within or outside of the weighted fringe boarder. Both these extra materials 40, 41 are completely optional and need not be included with the cover at all.

### Front Portion:

Opening—

The front portion of the cover is the portion that one would see hanging off the hood of a stroller and covering the front opening of a conventional stroller. It is somewhere in this front portion location that there would be an opening 36. The opening 36 can be in any shape, length or width that is most suitable for the product and its purpose, which is to allow for ventilation, coverage and adaptability for both strollers and car seats. Preferably it would be ten inches long. Its purpose is also to allow the child's caregiver to be able to pass his/her hand through and have contact with the child. There can also be a flap attached to either close or expose the opening, the purpose of which is to allow for more or less insulation and/or coverage as desired.

To serve this purpose, this opening 36 may have a top and bottom portion. One portion can be covered by a UVA or non UVA mesh screen (i.e. a screen that can block out UVA and AVB rays). The other portion can be left uncovered. Both portions can then be covered completely by the aforementioned flap. This configuration of the opening 36 is simply a suggestion. Alternative configurations such as placing a mesh screen on the whole opening, or not placing any mesh screen at all, are also viable options.

### Quality of Material:

In order to provide warmth, the material for the product can be made of some substantial material such as wool, fleece, canvas or any other type of insulating cloth; the purpose being to insulate the child inside the stroller or car seat and/or to add more stiffness and shape to the cover as opposed to its being more flimsy.

Alternatively, the product can also be made of material that is thinner or less substantial such as, but not limited to, a thin cotton cloth or angora material. Using material of this nature is useful in warmer weather in order to keep the baby inside the car seat or stroller cool.

### The Cover as Used on a Car Seat

As mentioned earlier, this product can alternate as a cover for both a car seat and stroller. When placed on top of a car seat 42, it is expected that the attachment devices such as the button snaps 8, 9 on top of the cover will remain engaged to accommodate the stroller being used. In other words, the engagement of the attachments on top of the cover most likely need not change to accommodate the car seat.

Once fitted onto the car seat, the user will find that the back triangular shaped back top 6 that was created on the top of the cover when the attachment devices were engaged, now lies on top of the open hood 43 of the car seat 42. Also, the small triangular pocket 10 that was created at the front top 5 area when the attachment devices were engaged, now lies on top of or just behind of the car seat's handle 44. The placement of this pocket 10 will allow the user room to grab and hold onto the car seat's handle bar 44 if he/she wants to grab it in order to pick up the car seat 42.

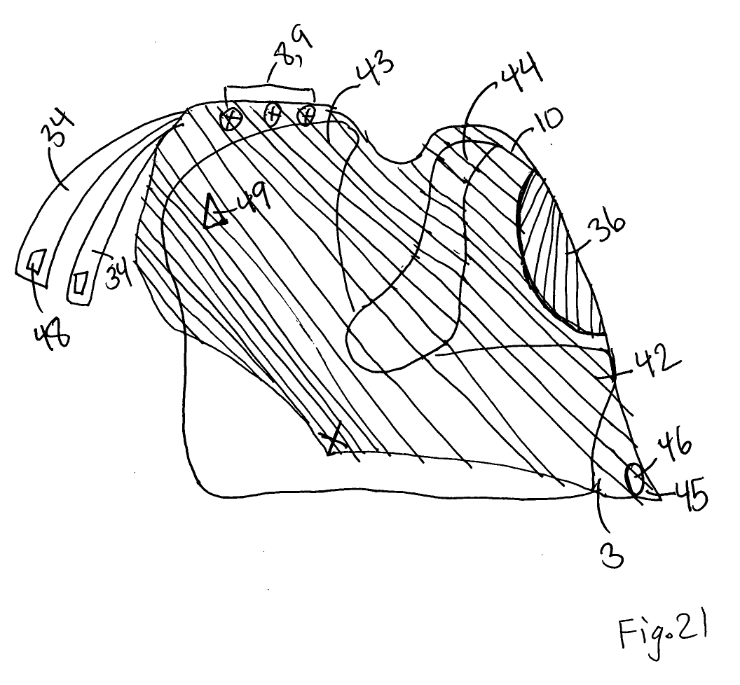

Once the cover is on top of the car seat, the user will notice that the material flows over onto the floor at the bottom. In order to avoid the cover 3 from dragging onto the floor while used as a car seat cover, the user can tighten the cover 3 around the car seat by utilizing fastening or securing devices the location of which would be, once fitted on the car seat, preferably at the lower end corner 37 of the cover 3 to another portion of the cover 3 that is preferably about nineteen inches above it along the sloped side. Fastening devices would be placed in both these locations. These attachments are represented in FIG. 21 by an o 46 and x 47.² Engagement of these attachment devices will result in the material of the cover 3 which lies past the car seat draped on the floor, being lifted up and tightened around the car seat for a more secure fit. The attachment devices here can be snaps, buttons, Velcro, ribbons or any other attachment device suited for the stated purpose. ² Please note that previously an attachment device 37.1 in the same location at the edged corner 37 was used to shorten the front length of the cover while on top of a conventional stroller. Thus, one attachment device in this location 37 can serve both purposes.

The other drag from the cover 3 while fitted on the car seat may come from the extra material 40, 41 that hangs off the lower side portion of the cover, if such extra material 40, 41 exists. This portion, however, can easily be attached up to the material of the cover by Velcro or other fastening devise. Most likely the fastening device will be the same one that was strategically placed for this extra material to wrap around the back bar.

What may also be helpful when the cover is placed on top of a car seat is avoiding the elongated top 33 or the two extensions 34 that are meant to wrap around the stroller's handle bars from dragging onto the floor. In order to do this, the end of the elongated top 33 or the extensions 34 may include some kind of method for attaching it onto some part of the cover and placing it out of the way of the floor. In FIG. 21, at the ends of the two extensions 34 are squares 48 depicting some form of attachment device. At some random place on the cover is a triangle 49, which depicts the matting attachment device for the squares 48, or the location where the square 48 can hook on to.

1. A covering for an infant carrying device, comprising:
a) a top portion comprising a size adjustment element allowing for adjustment of the size of the covering,
b) a front portion integral with, and adjacent to said top portion,
c) a bottom edge portion adjacent to and integral with said front portion, top portion, or combination thereof, providing a bottom edge border for said covering,
wherein said covering can be adjusted to fit over a variety of different infant carrying devices, said variety including strollers and car seats.

2. The covering of claim 1, said adjustment element of said top portion comprising at least one pair of opposing and attachable fastening elements, wherein the size of said covering can be reduced by attaching said fastening elements.

3. The covering of claim 2, said adjustment element comprising a plurality of pairs of opposing and interlockable fastening elements, forming first and second opposite rows, wherein said first and second rows can be at least partially fastened to reduce the size of said covering.

4. The covering of claim 1, further comprising a transparent window on said front portion, said top portion, or both.

5. The covering of claim 1, said bottom edge portion comprising a weight element such that said bottom edge portion is heavier than the top and front portions, by volume of material forming said portions.

6. The covering of claim 1, further comprising an attachment element for attaching said covering to said infant carrier device, said attachment element being coupled to said top portion, front portion, bottom edge portion, or combination thereof.

7. The covering of claim 6, said attachment element comprising at least one strap.

8. The covering of claim 1, said infant carrying device including a top, wherein said portion of said covering comprises a section for overlaying said top of said carrying device.

9. The covering of claim 1, said top of said infant carrying device comprising a canopy, handle, or combination thereof.

10. The covering of claim 1, said top portion comprising a hood for at least partially tenting said carrying device.

11. A method of adjusting the size of a covering for an infant carrying device, the covering forming a hood made of a flexible material, and adapted for covering at least a top portion of said carrying device, said method comprising, fastening together mating sections of said material, at a central location of said material, said mating sections comprising first and second inter-mating components, located at opposite and equidistant sides of said central location, such that when said mating sections are fastened the size of said covering is reduced.

12. A covering for an infant carrying device which is a stroller, comprising:
a) a top portion comprising a size adjustment element allowing for adjustment of the size of the covering,
b) a front portion integral with, and adjacent to said top portion,
c) a bottom edge portion adjacent to and integral with said front portion, top portion, or combination thereof, providing a bottom edge border for said covering, wherein said covering can be adjusted to fit a car seat.
